(19) United States
(12) Patent Application Publication
(10) Pub. No.: US 2008/0030762 A1
(43) Pub. Date: Feb. 7, 2008

(54) Data output control method, data output control server and data output system

(75) Inventor: Akemi Morita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/600,172

(22) Filed: Nov. 16, 2006

(30) Foreign Application Priority Data
Aug. 7, 2006 (JP) JP2006-215057

(51) Int. Cl. G06K 15/00

(52) U.S. Cl. 358/1.14

(57) ABSTRACT

A data output control method, where plural output apparatuses and an information processing terminal are connected via network, for outputting job data, from the information process terminal onto the output apparatuses, the method including the steps of: generating an output instruction at an information processing terminal for outputting job data onto an output apparatus selected by a first selection method; withholding transmission of the job data to the output apparatus until the output apparatus becomes capable of processing the job data, and obtaining a first authentication information for specifying a user, and storing it by correlating with the job data; obtaining second authentication information for specifying a user who has conducted the second selection operation of the output apparatus; comparing the first and second authentication information; and accepting a change operation, when they are identical.

### CROSS REFERENCE TO RELATED APPLICATION

The present application is based on Japanese Patent Application No. 2006-215057 filed with Japan Patent Office on Aug. 7, 2006, the entire content of which is hereby incorporated by reference.

### BACKGROUND OF THE INVENTION

1. Field of the Invention

The present invention relates to a data output control method, an output control server and a data output system for transmitting data from an information processing terminal to an output apparatus.

2. Description of Related Art

In an environment such as LAN (Local Area Network) in an office facility where output apparatuses such as printers, copiers and facsimile apparatuses and information processing terminals such as personal computers are connected thereto, print jobs and facsimile transmission jobs from each information processing terminal can be conducted on an arbitrary output apparatus. However, since it is difficult for users to identify which apparatus corresponds to which output apparatus and to select an output apparatus from a list of apparatus names as the size of the network environment becomes large. Users have experienced that printing material is outputted from an output apparatus located in an unexpected place. It has been inconvenient for users.

In order to solve the inconvenience, for example, Japanese Patent Application Open to Public Inspection Nos. H10-319795 and H10-320344 discloses apparatus designation system, in which a layout image of respective apparatuses is displayed, respective icons of which are displayed at the location on the layout image corresponding to the actual location of respective apparatuses, is capable of selecting an apparatus as an apparatus for executing jobs and as a replacement output destination by specifying the icon.

According to the prior art described above, event thought specifying an output apparatus and inputting a print job can be conducted by selecting an icon on the layout image screen, it was necessary to have installed printer driver into respective information processing terminals in the transmitting side in order to output the layout image. Since data pertaining to a print job which has been inputted are promptly transmitted to the output apparatus, when changing setting information pertaining to output (for example, a setting information for specifying dual surface printing/single side printing), there exists inconvenience that a user has to delete the print job, which has been inputted, from the output apparatus and to re-input the print job after changing the setting information.

When there exist many reservations of other preceding jobs at the output apparatus to which a job has been inputted, or when the output apparatus is under a waiting condition due to occurrence of jam associated with previous jobs, the job, which has been newly inputted, will not be executed. Thus, a user wants to change the output destination. However, as the same as the setting change, since the inputted job has already transmitted to the output apparatus and the job is under the waiting condition in the output apparatus, in order to change the output destination, the only way to avoid the problem is to delete the job once and input the same job to another output apparatus again. Further, when the functionality of the output-apparatus is different from the one, which had problems described above, it is necessary to set various output settings in response to the newly assigned output destination, which is stressful to the user.

When changing the setting information and an output destination against the job, which has been once inputted, it is important not to allow other people to freely conduct the operation.

An object of the present invention is to provide a data output control method, an output control server and a data output system, which is capable of reducing user operational load and at the same time of protecting unlawful change-operations by other people when changing setting information and an output destination after having issued a print job instruction to solve the problems described above.

### SUMMARY

An embodiment reflecting one aspect of the present invention to solve the problems described above is:

A data output control method, in an environment where a plurality of output apparatuses and an information processing terminal are connected via network, for outputting job data, which is to be processed by an output apparatus of the plurality of output apparatuses, from the information process terminal onto the output apparatuses, the method comprising the steps of: generating an output instruction at an information processing terminal for outputting job data selected onto an output apparatus selected by a first selection method, when the information processing terminal receives from a user a decision operation for outputting data, after receiving selection operations for selecting the job data and for selecting the output apparatus by the first selection method; withholding transmission of the job data to the output apparatus until the output apparatus becomes a state of being able to execute processing of the job data, and obtaining a first authentication information for specifying a user who has made the decision operation or for specifying the information processing terminal where the output instruction has been generated, and storing the first authentication information by correlating with the job data; obtaining, when receiving a second selection operation from a user for selecting an output apparatus by a second selection method at an information processing terminal, second authentication information for specifying a user who has conducted the second selection operation of the output apparatus or for specifying the information processing terminal where the second selection operation has been conducted; comparing the second authentication information and the first authentication information, which has been correlated with the job data, transmission of the job data to the output apparatus selected by the second selection method having been withheld; and accepting a change operation for changing setting information regarding output of the job data, when the first authentication information is identical to the second authentication information.

### BRIEF DESCRIPTION OF THE DRAWINGS

These and other objects, advantages and features of the invention will become apparent from the following description thereof taken in conjunction with the accompanying drawings in which:

FIG. 1 illustrates a configuration example of a data output system pertaining to an embodiment of the present invention;

FIG. 2 illustrates a main functional configuration of the data output system of the present invention;

FIG. 3 illustrates a data structure in the buffer memory 33 of the output control server of the present invention;

FIG. 4 illustrates an example of an output operation screen displayed on the display device 23 of the information processing terminal when issuing an instruction for printing a document from the information processing terminal;

FIG. 5 illustrates data transition pertaining to the output instruction;

FIG. 6 illustrates a sequence drawing showing data transition pertaining to the output instruction;

FIG. 7 illustrates an example of a default setting screen;

FIG. 8 illustrates an example of setting screen for accepting user's input;

FIG. 9 illustrates a flowchart showing a flow of the job inputting operation;

FIG. 10 illustrates various screens displayed when changing the setting of job, which has been inputted;

FIG. 11 illustrates a flowchart showing a flow of control pertaining to the operation for changing setting of job, which has been inputted;

FIG. 12 illustrates various screens displayed when changing the settings of data files stored in the box;

FIG. 13 illustrates a flowchart showing a flow of the control pertaining to a setting changing operation of data files stored in the box;

FIG. 14 illustrates an example of an operation screen displayed when changing the output destination of the job, which has been inputted;

FIG. 15 illustrates a drawing showing the condition of registered data in the storing section before and after of job movement;

FIG. 16 illustrates an example of a setting receiving screen displayed when moving jobs, which have been inputted;

FIG. 17 illustrates a flowchart showing a flow of control pertaining to the operation for changing an output destination;

FIG. 18 illustrates various screens displayed when conducting operation for transmitting and outputting data files stored in the box to the other output apparatus;

FIG. 19 illustrates a flowchart showing a flow of control pertaining to the operation when transmitting and outputting data stored in the box to other output apparatus;

FIG. 20 illustrates a flowchart showing operations pertaining to the storage of a data file to the box including the setting of a security level and the output of data file from the box;

FIG. 21 illustrates an example of the second setting receiving screen, which is capable of receiving settings pertaining to security; and

FIG. 22 illustrates various screens displayed when conducting output operations for outputting data files having a security level, which has been set, from the box.

### DETAILED DESCRIPTION OF THE PREFERRED EMBODIMENTS

Various embodiments of the present invention will be described below.

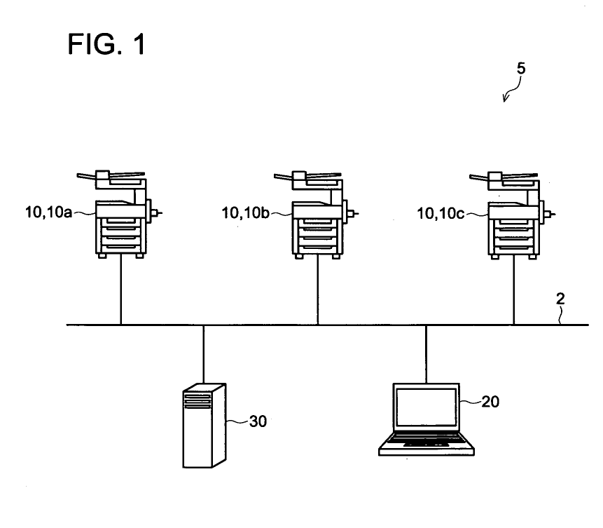

FIG. 1 illustrates a configuration example of a data output system 5 pertaining to an embodiment of the present invention. The data output system 5 comprises a plurality of output apparatuses 10, an information processing terminal 20 and an output control server 30, each of which is connected with each other via network 2.

The output apparatuses 10 are a printer, a facsimile apparatus, a multi-functional machine, which are apparatuses for conducting output process pertaining to image data including box save. In an example illustrated in FIG. 1, so called digital multi-functional machines (MFP) having a plurality of functions such as a facsimile function are used as output apparatuses 10. The functions of the output apparatuses 10 are not limited to these and may be apparatuses having at least one of a printing function, a facsimile transmission function and a saving function.

Box saving is a process for saving data into a box, ID of which is specified where the box which is identified by a box ID (for example a box number) is provided as a saving place of the data. When outputting data stored in the box, the box ID needs to be specified and access right to the box is authenticated by a password. When successfully completing authentication, access to the data saved in the box becomes possible. It is also possible to set a network system not to conduct authentication by a password.

The information processing terminal 20 is an information processing apparatus configured by personal computers having functions for transmitting print job and facsimile transmission job and for requesting an external terminal to execute output processes. The output control server 30 is a server having a communication function and a storage function. In FIG. 1, even though only one information processing terminal 20 is illustrated, however a plurality of information processing terminals may be connected to the network 2. Further, the first, second and third output apparatuses 10a, 10b and 10c are connected to the network 2 in FIG. 1. However, arbitrary plural output apparatuses may be connected to the network 2.

The output control server 30 in a data output system 5 receives jobs, for example a print job, which is transmitted from the information processing terminal 20. Then the output control server 30 withholds the jobs therein until the output apparatus 10, which has been designated as an output destination becomes ready to execute the jobs. At the same time the output control server 30 conducts controls of synchronization, for example, control of transmission timing until the output apparatus 10, which has been designated as an output destination, becomes ready to execute the jobs. While withholding data pertaining to the jobs, the output control server 30 is arranged to receive an instruction for changing the output destination and an instruction for changing setting information from the information processing terminal 20.

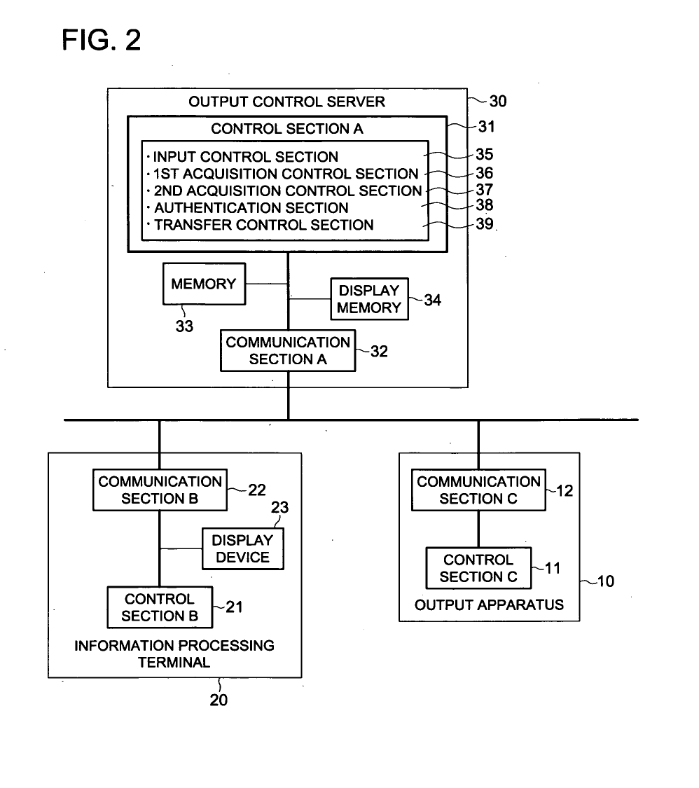

FIG. 2 illustrates a main functional configuration of the data output system 5. The output control server 30 comprises a control section A 31, a communication section A 32, a memory 33 and a display memory 34. The control section A 31 comprises an input control section 35, a 1^{st} acquisition control section 36, a 2^{nd} acquisition control section 37, an authentication section 38 and a transmission control section 39. The control section A 31 controls an output control server. The information processing terminal 20 comprises a control section B 21, a communication section B 22 and a display device 23. The output apparatus 10 comprises a control section C 11 and a communication section C 12.

A CPU (Central Processing Unit), a ROM (Read Only Memory) and a RAM (Random Access Memory) configure the control sections A, B and C of each apparatus. Further, the output apparatus 10 comprises a printer section, a facsimile control section, a scanner section and a data storage section.

The control section B 21 of the information processing terminal 20 transmits job data to be processed in the output apparatus 10, an output instruction including information for designating an output apparatus 10 to be used as an output destination, and authentication information to the output control server 30. The job data described above comprises output data such as document data and image data, and setting data such as output information. The output instruction described above includes information for showing a job type, such as print and facsimile transmission. The designation of the output destination is conducted by using an IP address of the output apparatus.

The authentication information is information for specifying the information processing apparatus 20. Here, the IP address, which has been assigned to the information processing terminal 20 is used as an authentication information for specifying the information processing terminal 20. Other information may be used as authentication information. A user ID of a user, who operates the information processing terminal 20 may be used as authentication information instead of authentication of the information processing terminal 20.

The communication section 32 of the output control server 30 receives the job data, an output instruction and authentication information, which may be an IP address of the information processing terminal 20. The memory 33 stores the job data received by the communication section 32 and the authentication information, which are correlated with the output apparatus 10, which has been assigned as an output destination. The memory 33 comprises, for example, a hard disk apparatus. The 1^{st} acquisition control section 36 and 2^{nd}

Acquisition control section 37 respectively conduct a first acquisition and a second acquisition of authentication.

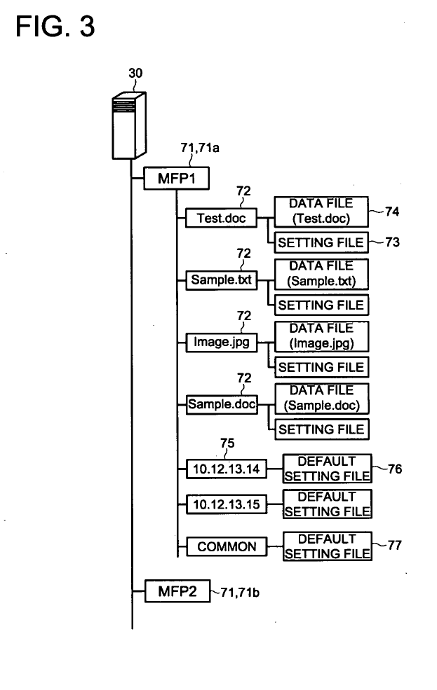

FIG. 3 illustrates a data structure in the memory 33 of the output control server 30. In the memory 33, the output destination folder 71 being a folder corresponding to the respective output apparatus 10 connected to the output system 5 is generated. Further a job folder 72 of jobs to be outputted to the output apparatus 10 deemed to be the output destination is generated for each job. The output destination folder 71 having a folder name corresponding to the name of the output apparatus 10, for example MFP1 and MFP2, or an IP (Internet Protocol) address, is generated. The output destination folder 71 corresponding to the output apparatus 10 is automatically generated when the output apparatus 10 is connected to the data output system 5 at the first time.

A setting file 73 storing setting data and authentication information of the job, and a data file 74 storing output data are stored in each job folder 72. The job pertaining to the job folder 72 is correlated with the output apparatus 10 to which the job is outputted by storing the job folder 72 storing the setting file 73 and the data file 74 into the output destination folder 71 corresponding to the output apparatus 10 being the output destination.

Referring back to FIG. 2, the explanation will be continued. The control section A 31 is to make output reservation of the job to the output apparatus 10 designated as an output destination of the job stored in the memory 33. The control section C of the output apparatus 10 internally registers the job in a reservation queue based on the output reservation from the output control server 30. Further, the control section C requests for job information by requesting the output control server 30 to transmit the setting data and the output data of the job, when the execution of the job, on which the output reservation has been conducted, becomes available.

A transfer control section 39 of the output control server 30 determines the timing when the output apparatus 10 being an output destination, to which the job is outputted, the setting data and the output data of each job being stored in the memory 33, becomes ready to execute the process of the job. Further, the transfer control section 39 transfers the setting data and the output data of each job being stored in the memory 33 to output apparatus in response to the determined timing when the output apparatus 10 becomes ready to execute the process of the job. The execution available timing is determined, for example, based on the notice from a job information request section 13 and an estimated processing time in the output apparatus 10, which as been obtained in the output control server 30.

The communication section B 22 of the information processing terminal 20 transmits an instruction for changing an output destination and an instruction for changing the setting information pertaining to the job stored in the memory 33 of the output server 30, to the output server 30. The authentication section 38 of the output control server 30 determines whether the instruction for changing an output destination and the instruction for changing the setting information, which have been received from the information processing terminal 20 are valid based on authentication information. Here, the authentication section 38 compares the IP address of the information processing terminal 20, from which the instruction for the change has been transmitted, with the IP address of the information processing terminal 20 from which the job was transmitted, the job being a change target of the change instruction. When the both ID addresses are identical, the output control server determines that the authentication is successful.

The control section A 31 of the output control server 30 controls a change process of the output destination of the job (a change instruction, which has been authenticated, when authentication is required), in response to the change instruction for changing the output destination received from the information processing terminal. The control section A 31 executes the change instruction for the changing the setting information received from the information processing apparatus (a change instruction, which has been authenticated, when authentication is required), in response to the change instruction for changing the setting information received from the information processing terminal. In the setting items in the setting information, there exist, for example, dual/single surface printing, number of printing sheets, the size the printing sheet and the margin of the printing paper sheets when outputting or printing.

The input control section 35 of the output control server 30 conducts controls for displaying an operation screen, by which an output instruction, the change instruction for changing the output destination and the change instruction for changing the setting information are issued, onto the display device 23 of the information processing terminal 20. The display memory 34 memorizes layout information pertaining to the setting location of the output apparatus 10 (it is just like map information). In the input control section 35, display data of an operation screen to be displayed on the information processing terminal 20 is generated and transmitted in response to the layout information stored in the display memory 34 and a job withholding condition in the memory 33.

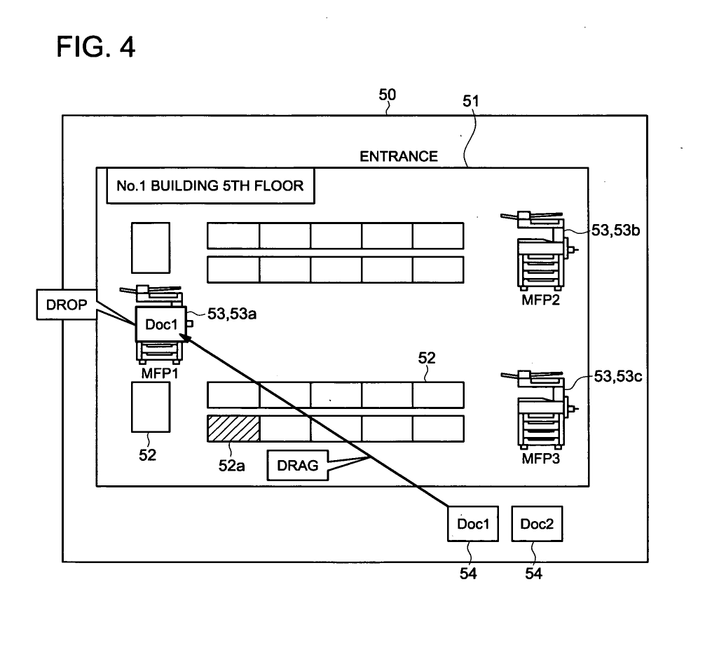

FIG. 4 illustrates an example of an output operation screen 50 displayed on the display device 23 of the information processing terminal 20 when issuing an instruction for printing a document from the information processing terminal 20. The output operation screen 50 is screen displaying a Web page provided by the input control section 35 of the output control server 30 by utilizing a browser function of the information processing terminal 20.

On the output operation screen 50, the layout image 51 showing the disposal of respective output apparatuses 10a, 10b and 10c is displayed. In the layout image 51, symbol marks, such as desks 52 placed on the flower are displayed according to the actual desk layout. Apparatus icons 53 being an icons corresponding to the output apparatuses 10 are displayed at the positions where the output apparatuses 10a, 10b and 10c are actually placed.

Each apparatus icon 53 includes ID information corresponding to the output apparatus 10 (here, a machine number such as MFP1, MFP2) In FIG. 4, the apparatus icons 53a, 53b and 53c respectively correspond to the first, the second and the third output apparatuses 10a, 10b and 10c illustrated in FIG. 1.

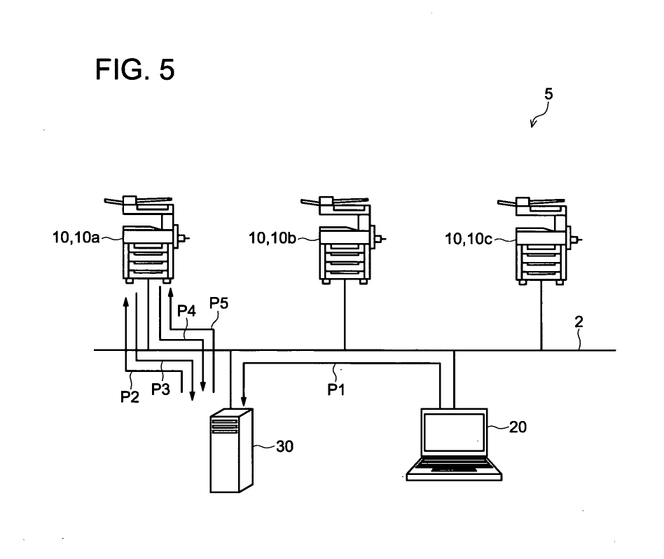

Further, the output operation screen 50 illustrates a data icon 54, which is an icon corresponding to job data. The data icon 54 additionally includes the file name of output data (Doc 1 in FIG. 5). The output operation screen 50 also displays the location of the information processing terminal displaying the output operation screen 50 (a desk 52a, a portion filled by slanting lines in FIG. 4).

The information processing terminal 20 is designed to generate an output instruction for transmitting the job data corresponding to the data icon 54 to the output apparatus 10 corresponding to the apparatus icon 53 by dragging the data icon 54 onto the apparatus icon 53 and dropping thereon by applying a mouse (a pointing device). Then, the job data are transmitted from the information processing terminal 20 to the output control server 30. The dragging and dropping operations correspond to that after conducting a selection operation for selecting the job data and a selection operation for selecting an output apparatus by the first selection method (drag), a user conducts a decision making operation for deciding the output apparatus to output the job data (drop). From a user's view point, it looks like that the drag and drop operation actually transmits a job to the output apparatus.

Next, the internal controls of the information processing terminal 20 used when the output instruction for transmitting a job (an output instruction: a print instruction) was sent from the information processing terminal 20 to the output apparatus 10, will be described below.

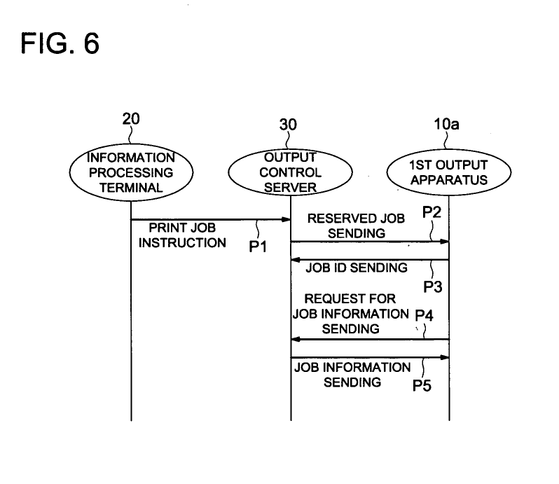

FIG. 5 illustrates data transition in the internal control described above by using a system configuration and FIG. 6 illustrates a sequence drawing showing data transition the same as FIG. 5. Each process having code of P1-P5 in FIGS. 5 and 6, corresponds to each other. Here, an output apparatus 10a is designated as an output determination.

Firstly, the output instruction generated by the operation method illustrated in FIG. 4 and the job data corresponding to the output instruction are transmitted from the information processing terminal 20 to the output control server 30 (P1). As illustrated in FIG. 3, the output control server 30 stores the data received from the information processing terminal 20 (including an IP address as the first authentication information), which is formed into files such as a setting file 73 and a data file 74. And the output control server 30 stores the setting file 73 and the data file 74 in the job folder 72 generated in the output destination folder 71a corresponding to the first output apparatus 10a designated as an output destination.

Further, the output control server 30 obtains a job type and an IP address of the information processing terminal 20, from which the job is transmitted, from the output instruction received from the information processing terminal 20. Then the output control server 30 transmits reservation information (including the IP address and the job type) to the first output apparatus 10a designated as the output destination in the output instruction (2P). The first output apparatus 10a, which has received the reservation job information, registers a function (print, facsimile transmission and box saving) corresponding to the job type, as an active job (a job, the output of which has not been completed yet or a job to be box-saved).

The first output apparatus 10a gives a Job ID to the job when registering and returns the job ID to the output control server 30 (P3). The output control server 30 received the job ID registers the job ID in the job folder 72 of the job, from which the reservation job information is issued.

The first output apparatus 10a transmits a job information transmission request including the job ID of the job to the output control server 30 when the first output apparatus 10a becomes a situation where any job registered as the active job can be executed. Based on this request, the first output apparatus 10a requests for transmission of the setting data and output data of the job to the output control server 30 (P4). For example, when previous print job has been finished, the first output apparatus 10a becomes a situation where the next print job in the reservation order can be executed, the transmission request for data pertaining the print job (a job information transmission request) is transmitted to the output server 30. Here, each output apparatus 10 is designed to keep only one job per each function therein and to become ready to process data pertaining to the next job when the execution of one job has been completed.

When the output control server 30 receives the job information transmission request from the first output apparatus 10a, the output control server 30 retrieves a job folder 72 in the output destination folder 71a corresponding to the first output apparatus 10a, the job ID of which is specified by the job information transmission request, and transmits the setting data and the output data stored in the job folder 72 to the first apparatus 10a (P5).

The output apparatus 10 received the setting data and the output data from the output control server 30 executes jobs such as a print process according to the received data, and box saving. When the function, which has been designated by the output instruction, is box saving, the output control server 30 actually transmits the setting data and the output data to the output apparatus 10 and may allow the output apparatus 10 to store the setting data and the output data therein or may store the setting data and the output data in the output control server 30 without transmitting them to the output apparatus 10 to allow the output apparatus 10 to look as if the output apparatus 10 stores them in a box at a first glance.

Next, an operation for registering a default value pertaining to the output setting and a job input operation will be described below.

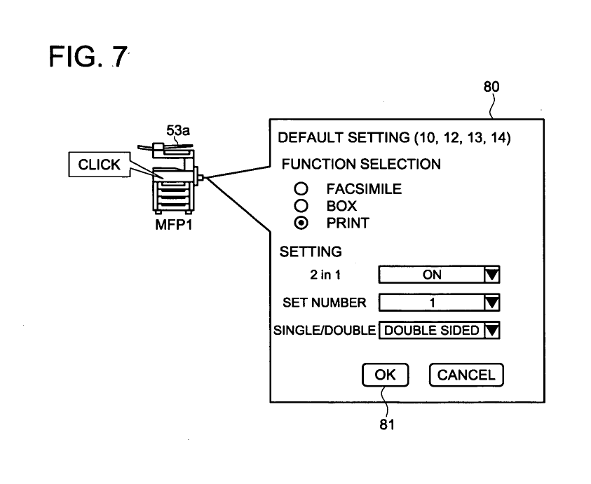

When clicking the apparatus icon 53 on the layout image 51 of the output operation screen 50 (the selection operation by the fourth selection method), a default setup screen 80 as illustrated in FIG. 7 will be popped up. A user is able to set up and register the default value (a predetermined value) of the output setting pertaining to the output apparatus 10 corresponding to the apparatus icon 53. This default value will be registered as a default value peculiar to the information processing terminal 20 (or the user) in the output apparatus 10.

In the default setting screen 80 illustrated in FIG. 7 “PRINT” as for the function (job type) selection, “ON” as for the selection of 2 in 1, “1” as for the selection of the set number for print paper sheets and “DOUBLE SIDED” as for the selection of single/double are selected. When operating an “OK button 81” after conducting a setting operation on the default setting screen 80, the default setting is completed and the setting contents of the default setting screen 80 is registered as a predetermined value in the output apparatus 10 corresponding to the apparatus icon 53, which has been selected by the click, and in the information processing terminal 20 by which the operation has been conducted.

For example, when conducting default setting by clicking the apparatus icon 53 corresponding to the output apparatus 10a on the output operation screen 50 illustrated in FIG. 4 to display the default setting screen 80, a folder 75 per a user, the folder name (here, IP address “10.12.13.14”), which is the name of the information processing terminal 20, by which the operation has been conducted, is generated under the output destination folder 71a of MFP1 in the data structure drawing illustrated in FIG. 3. A default setting file 76 including the setting values of the default setting screen 80 is stored in the folder 75, which is provide per a user. Thus, the default setting file 76 correlated with the first output apparatus 10a and the information processing terminal having IP address of “10,12,13,14” is registered.

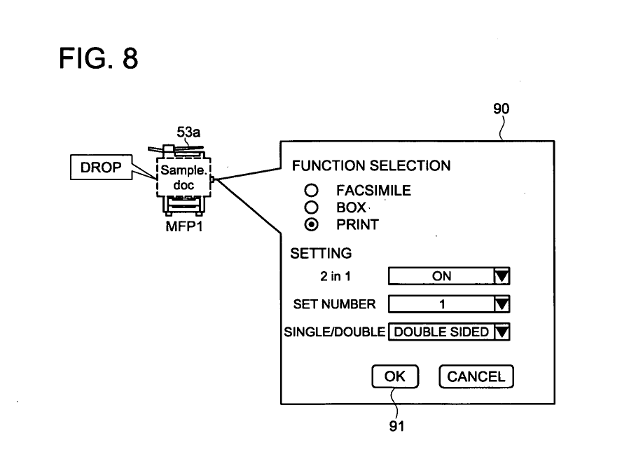

Next, when a job is inputted by the drag and drop operation on the layout image 51 as illustrated in FIG. 4, for example, from the information processing terminal 20 having IP address “10. 12. 13. 14”, and the first output apparatus 10a is assigned as an output destination, the setting reception screen 90 (FIG. 8) having default values (initial values) for respective setting items which have been set in advance on the default setting screen 80 illustrated in FIG. 7 is poped up. Confirming the setting contents and pushing down an OK button 91 after appropriately conducting the operation of the setting change when the change is required, complete the job input operations. Then, the output instruction including setting data corresponding to the setting value fixed on the setting reception screen 90 and output data are transmitted to the output control server 30.

The system may be arranged to display the setting reception screen 90 described above when the drag and drop operation is conducted by the right click, and may be arranged not to display the setting reception screen 90 and to input the job with the default value displayed as an initial value in the setting reception screen 90 as a setting value of the output setting when the drag and drop operation is conducted by the left click.

By doing this way described above, since the operation pertaining to the job input operation can be reduced by one operation for the user who frequently executes the job with a default setting condition, the usability can be improved. When a dedicated default value corresponding to the information processing terminal 20 used for the operation is not registered, the common default value (common to all information processing apparatus 20) to the output apparatus 10, which has been designated as the output destination may be used to display the setting reception screen 90 regardless of left click or right click.

Each information processing terminal 20 can set a default value dedicated to the information setting terminal 20 against the second output apparatus 10b. For example, when the default value described above is set for the first output apparatus 10a, and different default settings (for example, “FACSIMILE” is selected for the function selection, “NO” is set for 2 in 1, “1” is selected for the number of print paper sheets and “SINGLE” is selected for the selection of DUAL/SINGLE) is registered, a user can use the first output apparatus 10a and the second output apparatus 10b corresponding to the use. Further, since the registration of the default settings can be separately conducted per a user (per the information processing terminal 20), the default value can be set in each output apparatus 10 in response to the preference of the user, each user can use the plurality of output apparatuses 10 corresponding to his or her own purposes and the plurality of output apparatuses 10 connected to network 2 can be used based on the default settings, which are set dedicated for his or her own purpose.

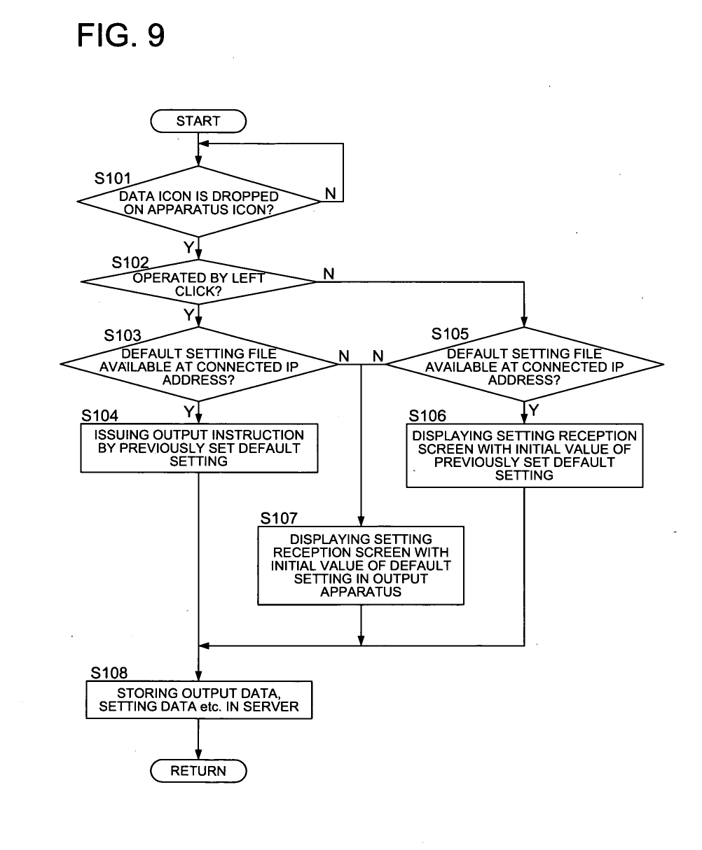

FIG. 9 illustrates a flowchart showing a flow of the job input operation described above. On the layout image 51, the job input operation is conducted by the drag and drop operation of a data icon 54 onto the apparatus icon 53 (step S101: Y), and when the operation is conducted by a left click (step S102: Y), whether the default setting file 76 corresponding to the IP address of the information processing server 20, by which the operation is conducted, is registered in the output control server 30 is checked (step S103). When the default setting file 76 has been registered (step S103: Y), the default value registered in the default setting file 76 is set as a setting value pertaining to the setting information of the output and the output instruction is issued. Then the job is inputted (step S104). Based on the operation described above, the output instruction including the setting data and the output data are transmitted to the output control server 30 and stored therein (step S108).

On the other hand, when the drag and drop operation is not conducted by the left click (step S102: N), whether the default setting file 76 corresponding to the IP address of the information processing terminal 20 by which the operation has been conducted is registered is checked (step S105). When the default setting file 76 has been registered (step S105: Y), the setting reception screen 90 in which the default value registered in the default setting file 76 is set as an initial value is displayed (step S106).

In the setting screen 90, the user confirms the setting contents and pushes the OK button 91 to complete the job input operation. Then, the output instruction including the setting data corresponding to the setting contents of the setting reception screen 90 and the output data are transmitted to the output control server 30 and saved therein (step S108).

Regardless of left click or not, when the default value corresponding to the IP address of the information processing terminal 20 where the drag and drop operation has been conducted, is not registered in the output control server 30 (step S103: N or step S105: N), the setting reception screen 90 where a common default value pertaining to the output apparatus 10 specified as an output destination is set as an initial value is displayed (step S107). After the user has completed the change operation in response to the necessity, when the user pushes down the OK button, the job input operation completes and the output instruction including the setting data corresponding to the setting contents of the setting reception screen 90 and the output data are transmitted to the output control server 30 and saved therein (step S108).

Next, the operation for changing the setting information of the job, which has been inputted according to the operations described above, will be described. As described above, since the setting data of the job and the output data are stored in the output control server 30 after the job has been inputted until the output apparatus 10, which is designated as a output destination, becomes a state where the job can be executed, the setting change against the job, which has been inputted from a user, can be accepted while the job setting and the output data are kept in the output control apparatus 30.

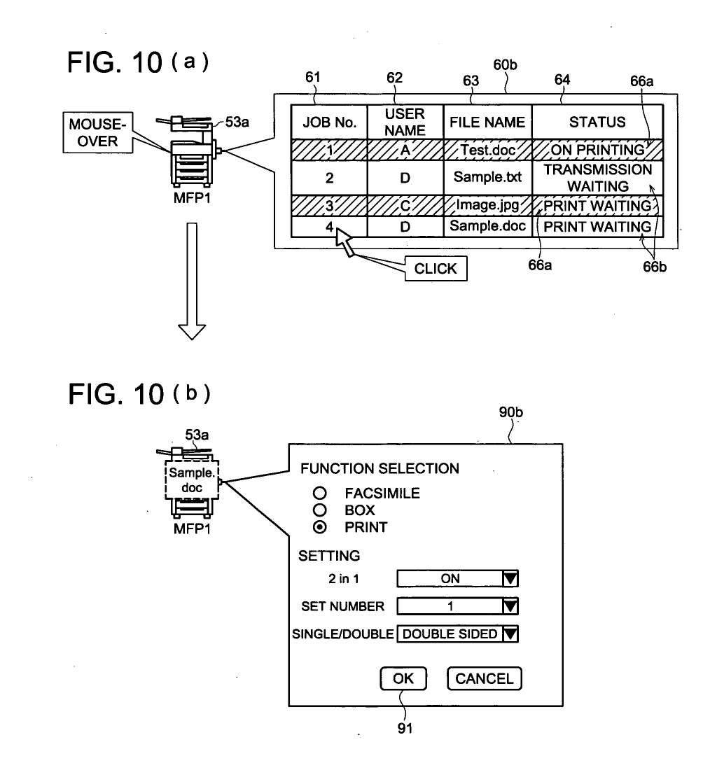

Concretely, when moving a mouse pointer onto the apparatus icon 53 by the mouse operation on the output operation screen 50 illustrated FIG. 4 (so to speak, “mouse-over”: selection by the second selection method), an active job list 60 as shown in FIG. 10(a) is popped up. The active job list 60 is to list index information pertaining to the jobs, which has been inputted but the output of which has not completed yet. The output apparatus 10 is designated as an output destination of the job. The active job list 60 displays the job number 61, a user name 62, a file name 62 and a state 64 (on printing and print waiting, etc.).

In the job list 60, only the job inputted from the information processing terminal 20 on which the mouse-over operation has been conducted can be selected, and the job inputted from other information processing terminal 20 is arranged not to be selected. Here, the IP address of the information processing terminal 20 on which the mouse-over operation has been conducted (the second authentication information) is compared with the IP address registered in the setting file 73 when the job was inputted, (the IP address of the information processing terminal 20 on which the job input was conducted: the first authentication information). When theses IDs are identical, the job is displayed so that the job is selectable. In FIG. 10(a), the index information 66a of the jobs, which cannot be selected, are illustrated in gray-out (in FIG. 10(a), they are shown in slanted lines.).

A user can select any index information 66b being not gray-out by conducting a click operation. For example, in FIG. 10(a), when the job having a job number “4” is selected, a setting reception screen 90b is popped up as illustrated in FIG. 10(b). In the setting reception screen 90b, a setting value registered in the setting file 73 of the job corresponding to the selected index information is initially displayed. The user may conduct an operation for changing the setting value according to the necessity, and complete the setting by pushing down the OK button 91.

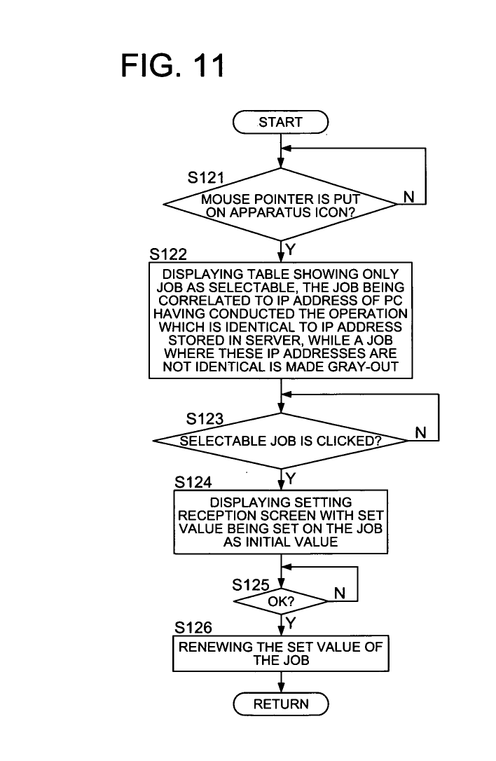

FIG. 11 illustrates a control flow pertaining to the change operation described above. In the output operation screen 50 illustrated in FIG. 4, when the mouse pointer is moved onto any one of the apparatus icons 53 (mouse-over) (step S121: Y), the IP addresses of the jobs stored in the job folder 72 stored in the output destination folder 71 of the output destination of the output apparatus 10 corresponding to the apparatus icon 53 selected by the mouse-over operation (the first authentication information) is compare with the IP address of the information processing terminal 20 on which the mouse-over operation was conducted (the second authentication information) to check whether both IDs are identical each other. Then, with regard to the jobs, the active list 60 is generated and displayed on the output operation screen 50, in which when the IP addresses of the jobs are identical each other, the job can be displayed as a selectable job therein, and when the IP addresses of which is not identical each other, jobs can be displayed as non-selectable (gray-out) therein (step S123).

When a user selects a selectable job in the active job list 60 (step S123: Y), the output control server 30 displays the setting reception screen 90 in which the setting values registered in the setting file 73 of the job is deemed as initial values (step S124). When “OK” button 19 is pushed down (step S125: Y), the output control server 30 updates the setting file 73 in response to the setting contents of the setting reception screen 90 at that time (step S126) and completes the process (return).

As described above, since the output control server 30 confirms that the user who has inputted the job is identical to the user who is going to conduct the change operation by using IP address of the information processing terminal 20 as authentication information and to allow the user to conduct the change operation only when they are identical each other, other people cannot freely change the output settings while the output control server 30 is in a situation of waiting for output.

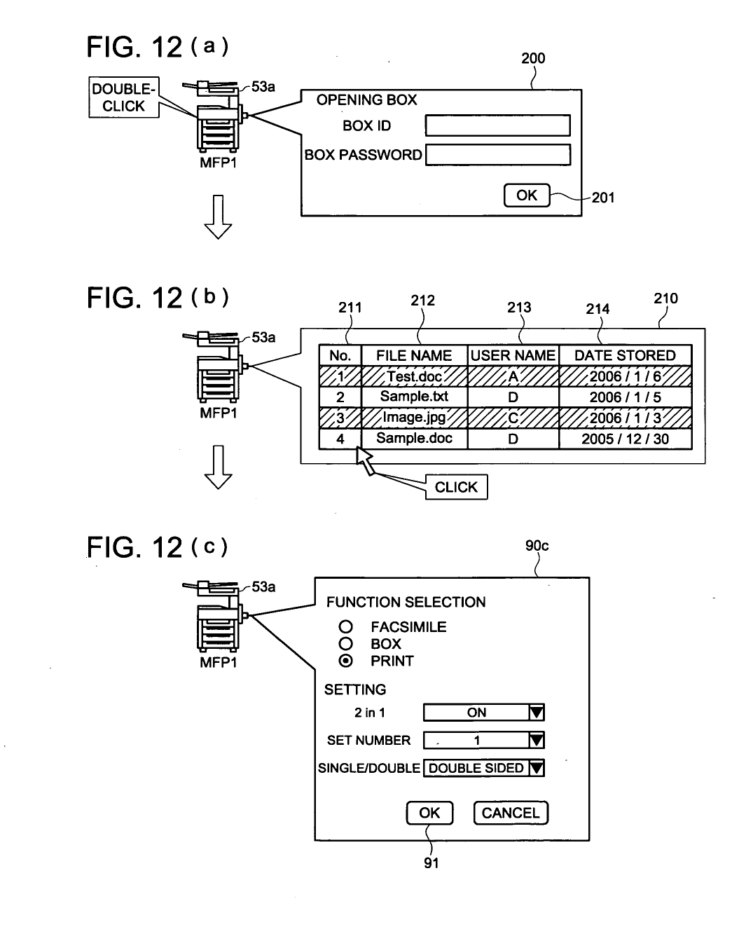

With regard to the output data stored in box-save as a saved file based on the output instruction for specifying the storage function, the setting values of the output setting can be changed as the same as described above. For example, when double-clicking the apparatus icon 53 on the output operation screen 50 illustrated in FIG. 4, the saved file saved in the box of the output apparatus 10 corresponding to the apparatus icon 53 can be seen. Concretely, when double-clicking the apparatus icon 53, a box selection authentication screen 200 as illustrated in FIG. 12(a) is displayed. In the box selection authentication screen 200, when pushing down an “OK” button 201 after inputting a box ID and a password, authentication of access right to the box of the inputted box ID is conducted based on the password, which has been inputted at the same time. When the authentication is successful, a saved file list 210 as illustrated in FIG. 12(b) will be displayed.

The saved file list 210 is a list showing index information pertaining to the saved file stored in the box. A data number 211, a file name 212, a user name 213 and storing date 214 are displayed as index information. When storing the output data as a saved file based on the output instruction of the storage function, the setting data and the authentication information (the IP address of the information processing apparatus 20 by which the storage operation has been conducted) are correlated with the saved file and stored.

In the case of box, only index information in the saved file having the same IP address as the information processing terminal 20 by which the operation has been conducted is selectively displayed. When the IP addresses of the saved files are not identical, the saved files are displayed in non-selectable by gray-out (a slanted line portion in the figure). When the index information capable of being selectable is selected in the saved file list, poped up and displayed is the setting reception screen 90c, in which the registered setting data is used as initial values, the registered setting data being correlated with the saved file corresponding to the selected index information. A user conducts the setting value change operation on the setting reception screen 90c and completes the setting change by pressing the “OK” button 91.

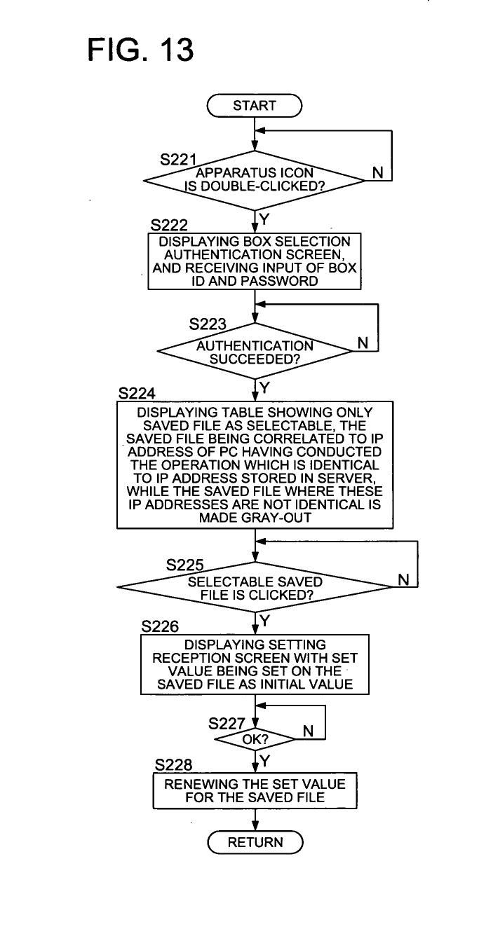

FIG. 13 illustrates a control flow pertaining to the change operation described above. In the output operation screen illustrated in FIG. 4, when any one of the apparatus icons 53 is double-clicked (step S221: Y), the output control server 30 displays the box selection authentication screen 200 and accepts the input operation of the box ID and the password (step S222). When the authentication is successful (step S223: Y), the output control server 30 determines whether the IP address (the first authentication information) correlated with the saved file is identical to the IP address (the second authentication information) of the information processing terminal 20 on which the double-click operation has been conducted. Then, the output control sever 30 popes-up (displays) the saved file list 210 on the output operation screen 50. When the IP address of the saved file is identical to the second authentication information, the saved files is displayed in selectable in the saved file list 210. When the IP address of the saved file is not identical the second authentication information, the saved file is displayed in non-selectable (gray-out) in the saved file list 210 (step S224).

When the user has selected the selectable saved file in the saved file list 210 (step S225: Y), the setting reception screen 90c where the registered setting data correlated with the saved file has been set as an initial value is displayed (Step S226). Then, after receiving the change operation for changing the setting value according to the necessity of the user, when the “OK” button is pushed down (step S227: Y), the setting data registered in correlation with the saved file based on the setting value on the setting reception screen 90c is updated (step S228) and the process completes (return).

Next, the operation used when changing the output destination of the inputted job will be described.

From the foregoing description, since the output server 30 keeps the setting data of the job and the output data after the job has been inputted until the output apparatus 10 designated as an output destination becomes a state where the job can be executed, the output control server is arranged to receive the change of the output destination of the inputted job from the user.

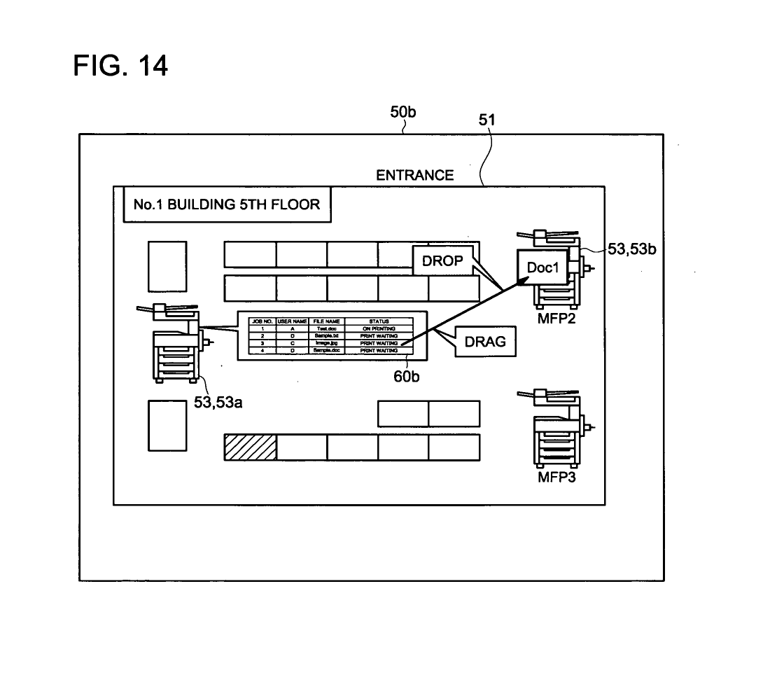

In an embodiment of the present invention, the output destination of the output data can be changed by the drag and drop operation shown in the output operation screen 50b as illustrated in FIG. 14. Namely, when dragging the data icon 54 onto the apparatus icon 53a on the layout image 51, or conducting the mouse over operation (the selection operation of the output apparatus by the third selection method), the active job list 60b of the output apparatus 10a will be displayed. Then when selecting the target job and dragging and dropping it onto the other apparatus icon 53b, the output destination change instruction for changing the output destination of the job to the output apparatus 10b corresponding to the apparatus icon 53b being the drop destination is transmitted to the output control server 30. In the example illustrated in FIG. 14, the output job of “Doc 1” is selected from the active job list 60b and dragging and dropping it onto the apparatus icon 53b to move the output job of “Doc 1” from the first output apparatus 10a to the second output apparatus 10b.

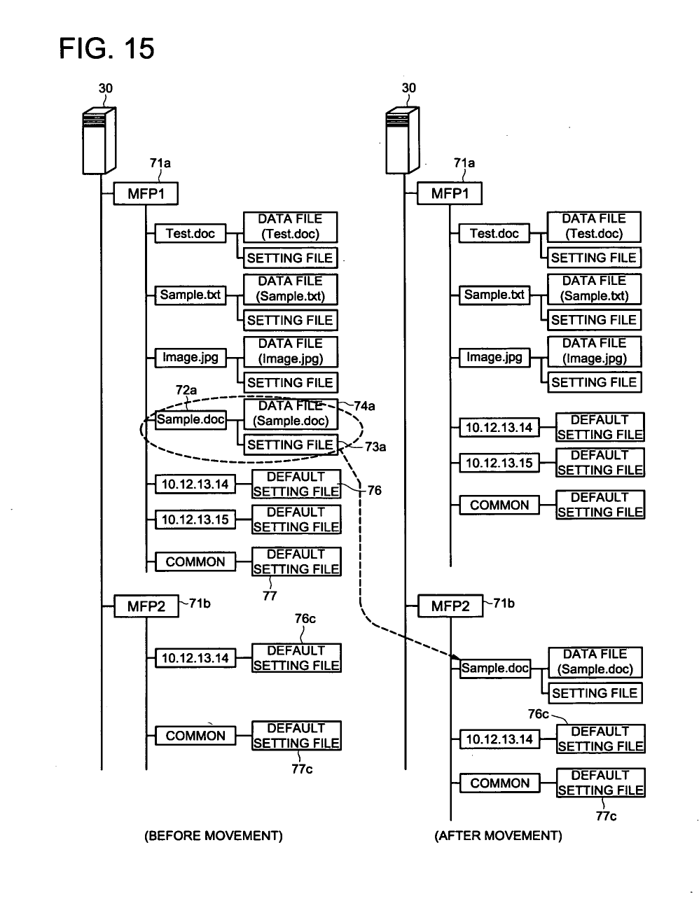

The output control server 30, which has received the output destination change instruction, moves the data pertaining to the job to be changed under the output destination folder 71 corresponding to the output apparatus 10, which is a moving destination after the change. For example, in the case of an example illustrated in FIG. 15, the job folder 72a of “sample.doc” in the output destination folder 71a corresponding to the output apparatus 10a being an output destination before the change is moved together with the folder (together with a data file 73a and the a setting file 74a there under) under the output destination folder 71b corresponding to the second output apparatus 10b being the moving destination. When moving the job file, a notice for canceling the job may be issued to the output apparatus 10. Or when a job information transmission request is transmitted from the output apparatus 10, the notice for canceling the job may be return to the output apparatus 10.

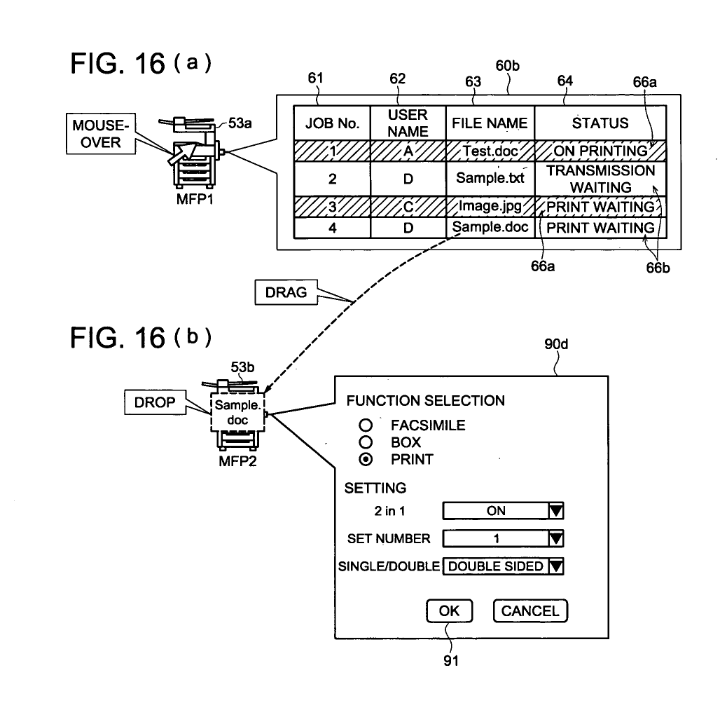

In the active job list 60b illustrated in FIG. 16(a), the selection of the job inputted from the information processing terminal 20 where the mouse-over operation and the drag operation for displaying the job list 60b has been conducted is allowed and the selection of the job from the other information processing terminal 20 is not allowed. Namely, the same as the case illustrated in FIG. 10, the IP address of the information processing terminal 20 where the mouse-over operation has been conducted (the second authentication information) is compared with the IP address registered in the setting file 73 when the job was inputted (the IP address-of the information processing terminal 20 when the job input operation was conducted: the first authentication information). The job having the first authentication information, which is identical to the second authentication information thereof is displayed in selectable. The job having the first authentication, which is not identical to the second authentication information thereof is displayed in gray-out being non-selectable. For example, in the case illustrated in FIG. 16(a), the operation for displaying the active job list 60b is conducted by a user “D”. The user “D” is able to move and to delete the jobs having job numbers “2” and “4” which have the user name “D”.

When selecting a selectable job in the active job list 60b by a clicking operation and dragging & dropping it onto other apparatus icon 53b, the setting reception screen 90d as illustrated in FIG. 16(b) is displayed. A user can set various setting information pertaining to the output of the second output apparatus 10b being an output destination. Still, the setting reception screen 90d need not be displayed. It is also possible that when conducting a drag & drop operation by a right clicking, the setting reception screen is displayed and when conducting a drag & drop operation by a left clicking, the setting values before movement may be applied as setting values of the setting information of the output in the moving destination without displaying the setting reception screen 90d.

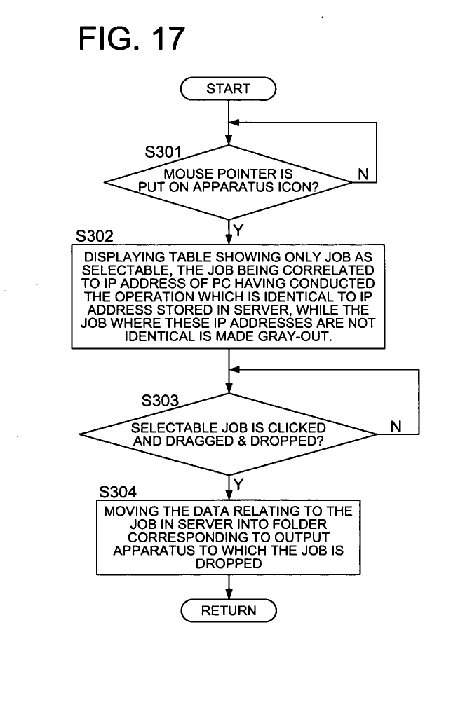

FIG. 17 illustrates a control flow pertaining to the output destination change operation. In the output operation screen illustrated in FIG. 14, when the mouse pointer is moved onto any one of apparatus icons 53 (the output apparatus selection by the third selection method) (step S301: Y), determined is whether the IP address of each job (the first authentication information) registered in the job folder 72, the job folder being saved in the output destination folder 71 of the output apparatus 10 corresponding to the apparatus icon 53 selected by the mouse pointer, is identical to the IP address of the information processing terminal 20 (the second authentication information) where the movement operation of the mouse pointer has been conducted. Then, with regard to the jobs, the active list 60 is generated and displayed on the output operation screen 50, in which when the IP addresses of the jobs are identical each other, the job can be displayed as a selectable job therein, and when the IP addresses of the jobs are not identical each other, jobs can be displayed as non-selectable (gray-out) therein (step S302).

When the user selects a selectable job in the active job list 60 and drags & drops the job onto the other apparatus icon 53 (step S303: Y), as illustrated in FIG. 15, the setting file 73 and the data file 74 of the job are moved (step S304) under the output destination folder 71 corresponding to the output apparatus 10 of the moving destination and the process is completed (return).

The initial values displayed on the setting reception screen 90d in the output destination change operation described above may be used as a default values of the user (the information processing terminal 20 being under operation) in the second output apparatus 10b being the moving destination or common default values in the second output apparatus 10b being the moving destination.

For example, when job movement is conducted as illustrated in FIG. 15 based on the operation from an information processing terminal 20 having IP address of “10. 12. 13. 14”, the setting reception screen 90d having predetermined values as an initial value saved in the default setting file 76c having the same IP address of “10. 12. 13. 14” registered under the output destination folder 71b corresponding to the second output apparatus 10b being the moving destination is displayed. When the default setting file 76c corresponding to the same IP address “10. 12. 13. 14” of the information processing terminal 20 which is under use, does not exist, the initial values is displayed by using a common default setting file 77 registered to the second output apparatus 10b.

The values used for the initial value of the setting reception screen 90d may be automatically set as setting values of setting information at the moving destination when the drag & drop operation is conducted by the operation of the special key without displaying the setting reception screen 90d.

Next, a case that a data file saved in the box is outputted to the other output apparatus 10 will be described below.

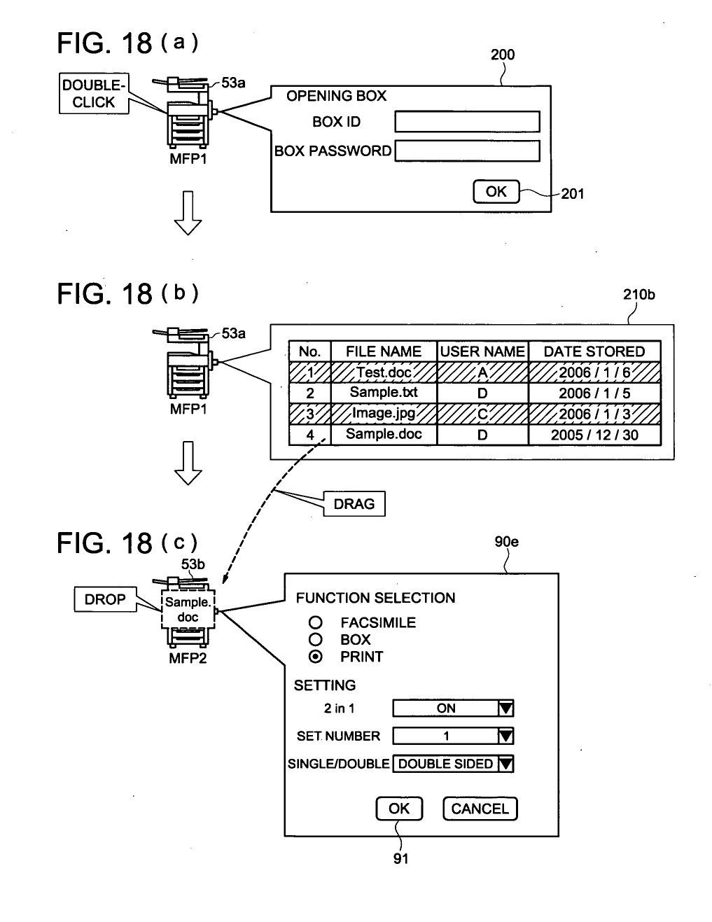

The file saved in the box of the output apparatus 10 corresponding to the apparatus icon 53 can be seen by double-clicking the apparatus icon 53 on the output operation screen 50. Concretely, when double-clicking the apparatus icon 53, the box selection authentication screen as illustrated in FIG. 18(a) is displayed. Pushing down the “OK” button 201 after inputting the box ID and the password conducts the authentication based on the password. When the authentication is successful, a saved file list 210b as illustrated in FIG. 18(b) is displayed. In the saved file list 210b, selectively displayed is only index information of the saved file correlated with the IP address being the same IP address of the information processing terminal 20 where the operation for displaying the saved file list 210b is conducted. The saved file having IP address being not identical will be gray-out (slant-lines in the figure) and displayed in non-selectable.

Selecting index information corresponding to the target saved file from the displayed saved file list 210b and dragging & dropping it onto the other apparatus icon 53b generates a job for executing the output process pertaining to the saved file, the job being executed on the output apparatus 10b corresponding to the apparatus icon 53b, which is a target of the drop-operation.

When selecting a saved file being selectable in the saved file list 210b and dragging and dropping it onto the other apparatus icon 53b, the setting reception screen 90e as illustrated in FIG. 18(c) is displayed. By using the setting reception screen 90e, the user can set values of the setting information used when outputting the data to be outputted, saved in the saved file, to the output apparatus 10 being the dropping destination.

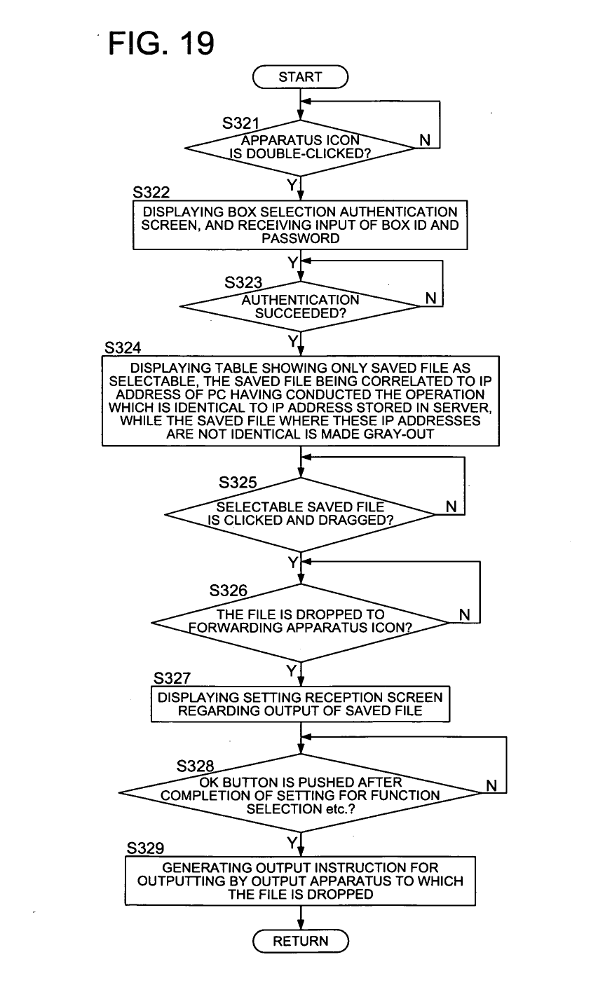

FIG. 19 illustrates a control flow pertaining to the change operation described above. When double-clicking any one of apparatus icons 53 on the output operation screen 50 (step S321: Y), the box selection authentication screen 200 is displayed and the box ID and the password are received (step S322). When the authentication is successful (step S323: Y), determined is whether the memorized IP address correlated with the saved file (the first authentication information), which is stored in the box is identical to the IP address of the information processing terminal 20 where the double-click operation has been conducted (the second authentication information). When the IP address of which is identical, the saved file is displayed in selectable style. When the IP address of is not identical, the file is displayed in non-selectable style (gray-out) in the saved file list 210b on the output operation screen 50 (step S324).

When the user selects a selectable saved file from the saved file list 210b (step S325: Y) and drags & drops it onto the other apparatus icon (step S326: Y), the setting reception screen 90e will be displayed (step S327). When completing the setting of function selection and pushing down “OK” button 91 (step S328: Y), the setting information used when outputting this saved file to the output apparatus 10 being the drop destination is set and the output instruction for transmitting this saved file on the output apparatus 10 being the drop destination is generated (step S329).

The initial values displayed on the setting reception screen 90e in the operation described above may be used as default values of the user (the information processing terminal 20 under operation) or common default values in the output apparatus 10 being the output destination. The values used for the initial value of the setting reception screen 90e may be automatically set as setting values of setting information at the moving destination when the drag & drop operation is conducted by the operation conducted by the special key without displaying the setting reception screen 90e.

As described above, since by utilizing the IP address of the information processing terminal 20, checked is whether the information processing terminal (or a user) where the box storage operation has been conducted is identical to the information processing terminal (or a user) where the operation for outputting data from the box is conducted. Only when they are identical, the output operation is allowed. Thus the other people cannot freely output the saved file stored in the saved box.

Next, the setting of security level used when conducting a box saving will be described. The setting of security level is to set the limiting items such as whether anybody can freely access the saved file stored in the box, whether the print output is allowed to other people. Namely, The setting of security level is to set the limiting items against the output data, which are not authenticated by the authentication information (here, IP address).

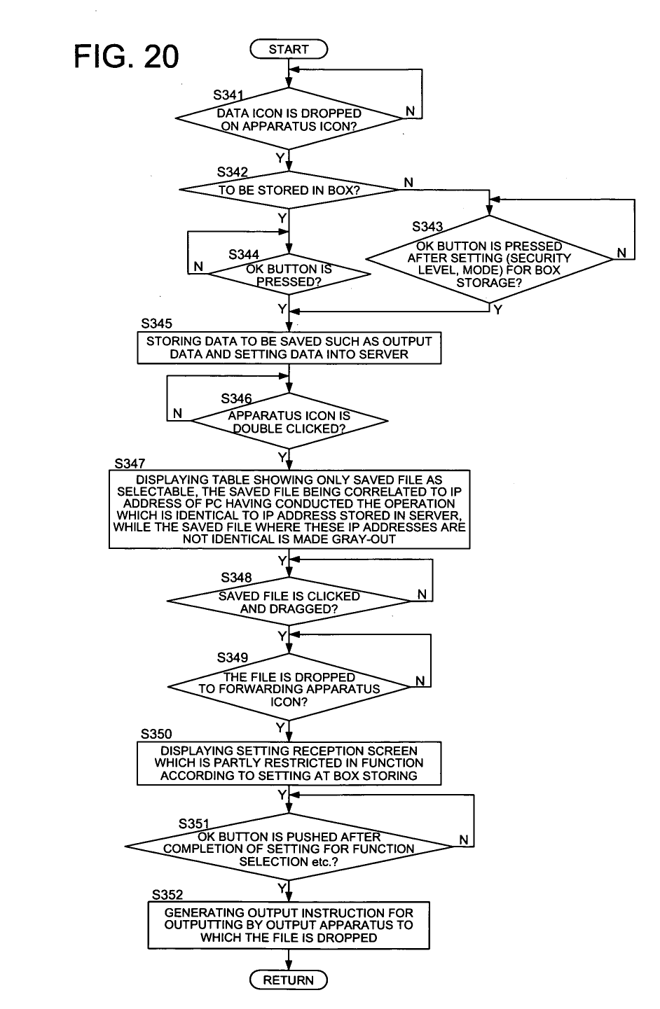

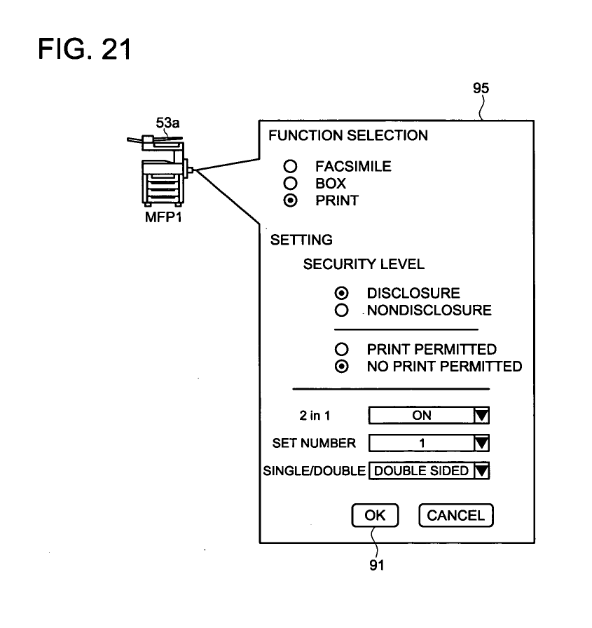

FIG. 20 illustrates an operation flow pertaining to the storage of the saved file to the box including the setting of security level and the output of the saved file from the box. When data icon 54 is dropped onto an apparatus icon 53 on the output operation screen 50 (step S341: Y), the second setting reception screen 95 as illustrated in FIG. 21 is popped-up. On the second setting reception screen 95, a setting “2 in 1” etc. will be received. Further, when a box save function is selected (step S342: Y), the setting of security level pertaining to the box save is received (step S343).

After completing the setting, when the “OK” button 91 on the second setting reception screen 95 is pressed (step S343: Y or Step S344: Y), a save instruction including the setting information (setting data) corresponding to the setting contents of the second reception screen 95 and the saved data (output data) are transmitted to the output control server 30. The saved data are saved in the box provided in the output control server 30 as a saved file (step S345).

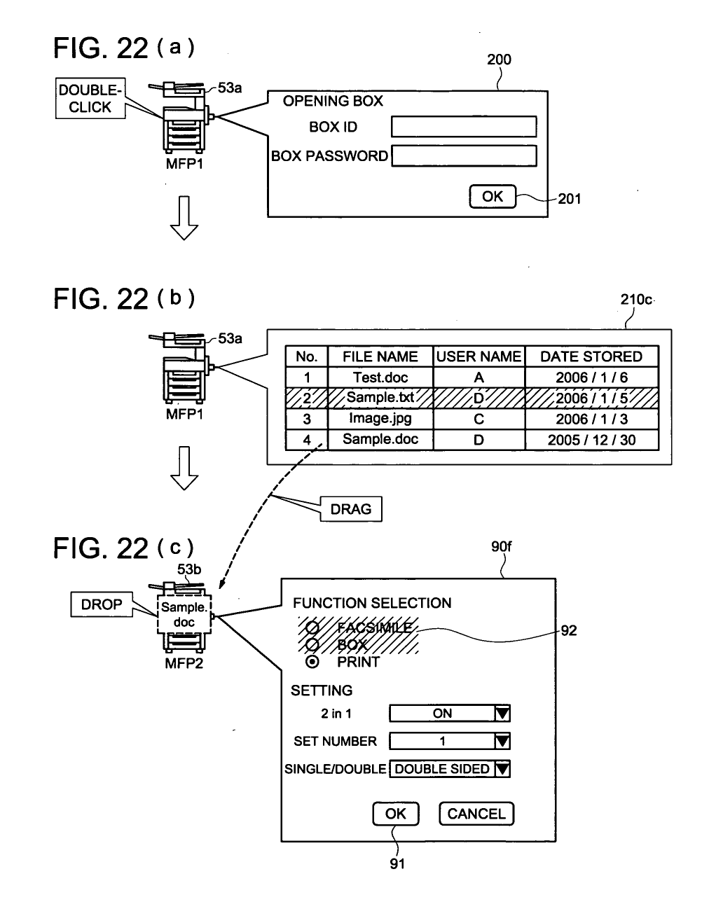

When the apparatus icon 53 on the output operation screen 50 is double-clicked (step S346: Y), as illustrated in FIG. 22(a), the box selection authentication screen 200 is displayed to receive a box ID and a password. When the authentication is successful, the saved file list 210c being the index information corresponding to the saved file saved in the correspondent box is displayed. The index information pertaining to the saved file having the security level set in “DISCLOSURE” is displayed in the saved data list 210c, and the index information pertaining to the saved file having the security level set in “NON-DISCLOSURE” is not displayed in the saved data list 210c. Further, with regard to the saved file, the security level of which is set in “NO PRINT PERMITTED”, the index information is gray-out so that the save file is not selected (step S347).

When the user selects a selectable-saved-file from the saved file list 210b and drags it (step S348: Y) and drops it onto the apparatus icon being the output destination (step S349: Y), the setting reception screen 90f as illustrated in FIG. 22(c) will be displayed (step S350). When completing the setting of function selection and pushing down the “OK” button 91 (step S351: Y), the setting information used when outputting this saved file to the output apparatus 10 being the drop destination is set and the output instruction for transmitting this saved file on the output apparatus 10 being the drop destination is generated (step S352).

In the setting reception screen 90f, a part of functions is limited according to the settings when the box saving is performed. For example, when selecting a saved file of others having setting of “PRINT PERMITTED” and conducting a drag and drop operation, a gray-out display is performed in a function selection row 92 so that other than a PRINT function cannot be selected. On the other hand, when selecting a saved file, which has been saved by himself or herself, all functions in the function selection row 92 are displayed in a selectable style.

As described above, in the box saving, since the display and the selectable function in the saved file list 210 are limited according to the security level set when storing, it is possible to limit the access in response to the importance and a confidential level. Further, even on the network environment, which is used by the other people, various usage of the box saving becomes possible while maintaining the security level.

As described above, the embodiment of the present invention has been described. The present invention is not limited to the above embodiment and various changes and modification may be made without departing the scope of the invention.

In the embodiment the control section A 31 of the output control server 30 is arranged to conducts the input control pertaining to the input operation from the output operation screen 50. However, it may also be configured that each information processing terminal 20 accesses the output control server 30, obtains the information pertaining to the registration condition of the job and the information of the setting file 73, generates the display data in the information processing terminal 20 side and display them.

The output instruction of a job and the change instruction for changing the output destination are conducted by the drag & drop operation on the layout screen. However, the operation method in the information processing terminal 20 is not limited to the above embodiment and for example, a determination button may be pushed down after respectively selecting the job data from the list of the data file and the output destination from the list of the output apparatus.

In the embodiment described above, various operations such as mouse-over, click and double click, are arranged to be accepted from a user, however the operation method is not limited to this. For example, in the case of a multi-functional mouse (having many operation buttons), by using these functions, the output control apparatus may be configured so that many kinds of selection operations from the user are accepted or the output control apparatus may be configured so that the operation by the keyboard, other than a mouse, is additionally used.

In the embodiment described above, the output control server 30 is arranged to store the output data. However, the information processing terminal 20 is configured so as to store the output data. For example, the printer driver of the information processing terminal 20 may be arranged to have function for controlling the timing for transmitting data to the output apparatus 10 to withhold the transmission until the output apparatus 10 being the output destination becomes ready for printing.

The authentication information is not limited to the IP address and may be a user or information, which is capable of specifying an information processing terminal. For example, when receiving the output instruction and the change operation from a user, it is possible to ask the user to input password to use the password as an authentication information.

The limit items used when not being authenticated are not limited to the examples described in the embodiment. As long as the items to limit the operation and process against the data to be outputted, arbitrary items will be accepted.

Embodiments reflecting some aspects of the present invention can be summarizes as described below.

(1) A data output control method, in an environment where a plurality of output apparatuses and an information processing terminal are connected via network, for outputting job data, which is to be processed by an output apparatus of the plurality of output apparatuses, from the information process terminal onto the output apparatuses, the method comprising the steps of: generating an output instruction at an information processing terminal for outputting job data selected onto an output apparatus selected by a first selection method, when the information processing terminal receives from a user a decision operation for outputting data, after receiving selection operations for selecting the job data and for selecting the output apparatus by the first selection method; withholding transmission of the job data to the output apparatus until the output apparatus becomes a state of being able to execute processing of the job data, and obtaining a first authentication information for specifying a user who has made the decision operation or for specifying the information processing terminal where the output instruction has been generated, and storing the first authentication information by correlating with the job data; obtaining, when receiving a second selection operation from a user for selecting an output apparatus by a second selection method at an information processing terminal, second authentication information for specifying a user who has conducted the second selection operation of the output apparatus or for specifying the information processing terminal where the second selection operation has been conducted; comparing the second authentication information and the first authentication information, which has been correlated with the job data, transmission of the job data to the output apparatus selected by the second selection method having been withheld; and accepting a change operation for changing setting information regarding output of the job data, when the first authentication information is identical to the second authentication information.

In the embodiment described above, after the output instruction is generated, the transmission of data to be outputted to an output destination, is withheld and a user is able to conduct a change operation for changing setting information pertaining to the data to be outputted until the output apparatus, which has been assigned as an output destination by an output instruction, becomes a state where the output apparatus is able to execute processing of the data to be outputted, which is pertaining to the output instruction. At this moment, the coincidence of a user who has issued the output instruction and a user who is going to conduct a change operation or the coincide of an information processing apparatus to be used for the change operation is checked based on authentication information. The change operation is permitted only for the data to be output, which have been authenticated. Here, withholding of transmission occurs when preceding jobs exist in the output destination of the output apparatus or occurrence of abnormal situations.

(2) A data output control method, in an environment where a plurality of output apparatuses and an information processing terminal are connected via network, for outputting job data, which is to be processed by an output apparatus of the plurality of output apparatuses, from the information process terminal onto the output apparatuses, the method comprising the steps of: generating an output instruction at an information processing terminal for outputting job data selected onto an output apparatus selected by a first selection method, when the information processing terminal receives from a user a decision operation for outputting data, after receiving selection operations for selecting the job data and for selecting the output apparatus by the first selection method; withholding transmission of the job data to the output apparatus until the output apparatus becomes a state of being able to execute processing of the job data, and obtaining a first authentication information for specifying a user who has generated the output instruction or for specifying the information processing terminal where the output instruction has been generated, and storing the first authentication information by correlating with the job data; obtaining, when receiving a second selection operation from a user for selecting an output apparatus by a third selection method at the information processing terminal, second authentication information for specifying a user who has conducted the second selection operation of the output apparatus or for specifying an information processing terminal where the second selection operation has been conducted; comparing the second authentication information and the first authentication information, which has been correlated with the job data, transmission of the job data to the output apparatus selected by the third selection method having been withheld; and accepting a change operation for changing setting information regarding output of the job data, only when the first authentication information is identical to the second authentication information.

(3) An output control server, which is connected with an information processing terminal and a plurality of output apparatuses via network, the output control server comprising: a communication section for receiving an output instruction to transmit job data for outputting to the output apparatus, and for receiving the job data pertaining to the output instruction from the information processing terminal; a memory for storing the job data received by the communication section, and a first authentication information for specifying a user who has conducted a generating operation of the output instruction or for specifying an information processing terminal where the generation operation of the output instruction has been conducted, wherein the first authentication information is correlated with the job data; and a control section including an input control section, a first acquisition control section, a transmission control section, a second acquisition control section and an authentication section,

wherein the input control section transmits display data to the information processing terminal to display an operation screen, and to generate an output instruction for outputting selected job data at an output apparatus selected by a first selection method, when receiving a decision operation for outputting data after receiving a job data selection operation and an output apparatus selection operation by the first selection method from a user, the first acquisition control section controls to obtain the first authentication information,

the transmission control section controls to withhold transmission of the job data to the output apparatus until the output apparatus, which has been selected as the output destination becomes a state where the output apparatus is able to execute processing of the job data,

the second acquisition control section controls to obtain a second authentication information for specifying a user who has conducted a selection operation or for specifying an information processing terminal where the selection operation has been conducted when receiving the selection operation of an output apparatus by a second selection method via the operation screen,

the authentication section controls to compare the second authentication information and the first authentication information, which has been correlated with the job data, transmission of the job data to the output apparatus selected by the second selection method having been withheld, and to authenticate the job data when the first authentication information is identical to the second authentication information, and

the input control section controls to accept a change operation for changing setting information pertaining to the job data, which have been authenticated by the authentication section, when receiving a selection operation of the output apparatus by the second selection method.

In the embodiment described above, the input control section of the output control server transmits display data to an information processing apparatus connected to network to display an operation screen thereon to receive various user operations via the operation screen. For example, the operation screen will be displayed as a Web page by utilizing a browser function of the information processing apparatus. After the output instruction is issued, the transmission of the job data to the output apparatus is withheld and the data to be outputted is correlated with the first authentication information and store in the memory, until the output apparatus, which has been designated as an output destination by the output instruction, becomes a state where the output apparatus is able to execute processing of the data to be outputted pertaining to the output instruction. A user can conduct a change operation for changing setting information pertaining to the output of the job data while the transmission is withheld. At this moment, the output control sever obtains the second authentication information for specifying the user, who conducts the change operation or information processing apparatus by which the change operation is conducted. Then the output control server determines whether the first authentication information is identical to the second authentication information. When identical, the change operation for changing the setting information is permitted only for the job data, the first and second authentication information of the job data being identical. Here, withholding of transmission occurs when proceeding jobs exist in the output apparatus at the output destination to which data are transmitted or occurrence of abnormal situations.

(4) An output control server, which is connected with an information processing terminal and a plurality of output apparatuses via network, the output control server comprising: a communication section for receiving an output instruction to transmit job data for outputting to the output apparatus, and for receiving the job data pertaining to the output instruction from the information processing terminal; a memory for storing the job data received by the communication section, and a first authentication information for specifying a user who has conducted a generating operation of the output instruction or for specifying an information processing terminal where the generation operation of the output instruction has been conducted, wherein the first authentication information is correlated with the job data; and a control section including an input control section, a first acquisition control section, a transmission control section, a second acquisition control section and an authentication section,

wherein the input control section transmits display data to the information processing terminal to display an operation screen, and to generate an output instruction for outputting selected job data at an output apparatus selected by a first selection method, when receiving a decision operation for outputting data after receiving a job data selection operation and an output apparatus selection operation by the first selection method from a user,

the first acquisition control section controls to obtain the first authentication information,

the transmission control section controls to withhold transmission of the job data to the output apparatus until the output apparatus, which has been selected as the output destination becomes a state of being able to execute a processing of the job data,

the second acquisition control section controls, when receiving a selection operation of an output apparatus by a third selection method via the operation screen, to obtain a second authentication information for specifying a user who has conducted the selection operation or for specifying an information processing terminal where the selection operation has been conducted,

the authentication section controls to compare the second authentication information and the first authentication information, which has been correlated with the job data, transmission of the job data to the output apparatus selected by the second selection method having been withheld, and to authenticate the job data when the first authentication information is identical to the second authentication information, and

the input control section controls to accept a change operation for changing setting information pertaining to the job data, which have been authenticated by the authentication section, when receiving a selection operation of the output apparatus by the second selection method.

(5) A data output system in which an information processing terminal, a plurality of output apparatuses, and an output control server are connected with via network, wherein the output control server comprising: a communication section for receiving an output instruction to transmit job data for outputting to the output apparatus, and for receiving the job data pertaining to the output instruction from the information processing terminal; a memory for storing the job data received by the communication section, and a first authentication information for specifying a user who has conducted a generating operation of the output instruction or for specifying an information processing terminal where the generating operation of the output instruction has been conducted, wherein the first authentication information is correlated with the job data; and a control section including an input control section, a first acquisition control section, a transmission control section, a second acquisition control section and an authentication section,

wherein the input control section transmits display data to the information processing terminal to display an operation screen, and to generate an output instruction for outputting selected job data at an output apparatus selected by a first selection method, when receiving a decision operation for outputting data after receiving a job data selection operation and an output apparatus selection operation by the first selection method from a user,

the first acquisition control section controls to obtain the first authentication information,

the transmission control section controls to withhold transmission of the job data to the output apparatus until the output apparatus, which has been selected as the output destination becomes a state of being able to execute processing of the job data,

the second acquisition control section controls, when receiving a selection operation of an output apparatus by a second selection method via the operation screen, to obtain a second authentication information for specifying a user who has conducted the selection operation or for specifying an information processing terminal where the selection operation has been conducted,

the authentication section controls to compare the second authentication information and the first authentication information, which has been correlated with the job data, transmission of the job data to the output apparatus selected by the second selection method having been withheld, and to authenticate the job data when the first authentication information is identical to the second authentication information, and

the input control section controls to accept a change operation for changing setting information only pertaining to the job data, which have been authenticated by the authentication section, when receiving a selection operation of the output apparatus by the second selection method.

According to an data output control method, an output control server and a data output system pertaining to the present invention, the transmission of job data to the output destination is withheld after the issuance of the output instruction until the output destination becomes to a state where the output destination is ready for executing the job and the operation for changing setting information pertaining to the output and the operation for changing the output destination are arranged to be received only for the job data, which have been authenticated by the authentication information. Thus it becomes possible that the user operation load when changing the setting information and changing the output destination can be reduced and at the same time an illegal change operation by others can be prevented.

What is claimed is:

1. A data output control method, in an environment where a plurality of output apparatuses and an information processing terminal are connected via network, for outputting job data, which is to be processed by an output apparatus of the plurality of output apparatuses, from the information process terminal onto the output apparatuses, the method comprising the steps of:
generating an output instruction at an information processing terminal for outputting job data selected onto an output apparatus selected by a first selection method, when the information processing terminal receives from a user a decision operation for outputting data, after receiving selection operations for selecting the job data and for selecting the output apparatus by the first selection method;
withholding transmission of the job data to the output apparatus until the output apparatus becomes a state of being able to execute processing of the job data, and obtaining a first authentication information for specifying a user who has made the decision operation or for specifying the information processing terminal where the output instruction has been generated, and storing the first authentication information by correlating with the job data;
obtaining, when receiving a second selection operation from a user for selecting an output apparatus by a second selection method at an information processing terminal, second authentication information for specifying a user who has conducted the second selection operation of the output apparatus or for specifying the information processing terminal where the second selection operation has been conducted;
comparing the second authentication information and the first authentication information, which has been correlated with the job data, transmission of the job data to the output apparatus selected by the second selection method having been withheld; and
accepting a change operation for changing setting information regarding output of the job data, when the first authentication information is identical to the second authentication information.

2. The data output control method of claim 1, wherein in the step of accepting a change operation, only the job data correlated to the first authentication information which is identical to the second authentication information is displayed in a table as selectable, and accepted is a change operation for changing setting information regarding output of the job data selected from the table.

3. A data output control method, in an environment where a plurality of output apparatuses and an information processing terminal are connected via network, for outputting job data, which is to be processed by an output apparatus of the plurality of output apparatuses, from the information process terminal onto the output apparatuses, the method comprising the steps of:
generating an output instruction at an information processing terminal for outputting job data selected onto an output apparatus selected by a first selection method, when the information processing terminal receives from a user a decision operation for outputting data, after receiving selection operations for selecting the job data and for selecting the output apparatus by the first selection method;
withholding transmission of the job data to the output apparatus until the output apparatus becomes a state of being able to execute processing of the job data, and obtaining a first authentication information for specifying a user who has generated the output instruction or for specifying the information processing terminal where the output instruction has been generated, and storing the first authentication information by correlating with the job data;
obtaining, when receiving a second selection operation from a user for selecting an output apparatus by a third selection method at the information processing terminal, second authentication information for specifying a user who has conducted the second selection operation of the output apparatus or for specifying an information processing terminal where the second selection operation has been conducted;
comparing the second authentication information and the first authentication information, which has been correlated with the job data, transmission of the job data to the output apparatus selected by the third selection method having been withheld; and
accepting a change operation for changing setting information regarding output of the job data, only when the first authentication information is identical to the second authentication information.

4. The data output control method of claim 3, wherein in the step of accepting a change operation, the job data correlated to the first authentication information which is identical to the second authentication information is displayed in a table as selectable, and accepted is a change operation for changing setting information regarding output of the job data selected from the table.

5. The data output control method of claim 1, further comprising the step of accepting a setting of restriction in cases where the first authentication information is not identical to the second authentication information.

6. The data output control method of claim 1, wherein the output instruction comprises a save instruction for saving the job data by correlating with the output apparatus.

7. The data output control method of claim 6, wherein the job data include data saved by the save instruction.

8. The data output control method of claim 1, further comprising the step of displaying apparatus icons, each of which corresponds to each of the plurality of output apparatuses, and a data icon corresponding to job data on an operation screen, wherein when a drag and drop operation is received, where the data icon is dragged and dropped on the apparatus icon, the output instruction is generated.

9. The data output control method of claim 8, wherein a layout image is displayed on the operation screen, and the apparatus icon is displayed in the layout image.

10. The data output control method of claim 1, the authentication information is an IP address of the information processing terminal.

11. An output control server, which is connected with an information processing terminal and a plurality of output apparatuses via network, the output control server comprising:
a communication section for receiving an output instruction to transmit job data for outputting to the output apparatus, and for receiving the job data pertaining to the output instruction from the information processing terminal;
a memory for storing the job data received by the communication section, and a first authentication information for specifying a user who has conducted a generating operation of the output instruction or for specifying an information processing terminal where the generation operation of the output instruction has been conducted, wherein the first authentication information is correlated with the job data; and
a control section including an input control section, a first acquisition control section, a transmission control section, a second acquisition control section and an authentication section,
wherein the input control section transmits display data to the information processing terminal to display an operation screen, and to generate an output instruction for outputting selected job data at an output apparatus selected by a first selection method, when receiving a decision operation for outputting data after receiving a job data selection operation and an output apparatus selection operation by the first selection method from a user,
the first acquisition control section controls to obtain the first authentication information,
the transmission control section controls to withhold transmission of the job data to the output apparatus until the output apparatus, which has been selected as the output destination becomes a state where the output apparatus is able to execute processing of the job data,
the second acquisition control section controls to obtain a second authentication information for specifying a user who has conducted a selection operation or for specifying an information processing terminal where the selection operation has been conducted when receiving the selection operation of an output apparatus by a second selection method via the operation screen,
the authentication section controls to compare the second authentication information and the first authentication information, which has been correlated with the job data, transmission of the job data to the output apparatus selected by the second selection method having been withheld, and to authenticate the job data when the first authentication information is identical to the second authentication information, and
the input control section controls to accept a change operation for changing setting information pertaining to the job data, which have been authenticated by the authentication section, when receiving a selection operation of the output apparatus by the second selection method.

12. The input control server of claim 11, wherein when the input control section accepts the change operation, only the job data correlated to the first authentication information which is identical to the second authentication information is displayed in a table as selectable, and accepted is a change operation for changing setting information regarding output of the job data selected from the table.

13. An output control server, which is connected with an information processing terminal and a plurality of output apparatuses via network, the output control server comprising:
a communication section for receiving an output instruction to transmit job data for outputting to the output apparatus, and for receiving the job data pertaining to the output instruction from the information processing terminal;
a memory for storing the job data received by the communication section, and a first authentication information for specifying a user who has conducted a generating operation of the output instruction or for specifying an information processing terminal where the generation operation of the output instruction has been conducted, wherein the first authentication information is correlated with the job data; and
a control section including an input control section, a first acquisition control section, a transmission control section, a second acquisition control section and an authentication section,
wherein the input control section transmits display data to the information processing terminal to display an operation screen, and to generate an output instruction for outputting selected job data at an output apparatus selected by a first selection method, when receiving a decision operation for outputting data after receiving a job data selection operation and an output apparatus selection operation by the first selection method from a user, the first acquisition control section controls to obtain the first authentication information,
the transmission control section controls to withhold transmission of the job data to the output apparatus until the output apparatus, which has been selected as the output destination becomes a state of being able to execute a processing of the job data,
the second acquisition control section controls, when receiving a selection operation of an output apparatus by a third selection method via the operation screen, to obtain a second authentication information for specifying a user who has conducted the selection operation or for specifying an information processing terminal where the selection operation has been conducted,
the authentication section controls to compare the second authentication information and the first authentication information, which has been correlated with the job data, transmission of the job data to the output apparatus selected by the second selection method having been withheld, and to authenticate the job data when the first authentication information is identical to the second authentication information, and
the input control section controls to accept a change operation for changing setting information pertaining to the job data, which have been authenticated by the authentication section, when receiving a selection operation of the output apparatus by the second selection method.

14. The output control server of claim 13, wherein the input control section displays only the job data correlated to the first authentication information which is identical to the second authentication information in a table as selectable, and accepts a change operation for output destination regarding the job data selected from the table.

15. The output control server of claim 11, wherein the input control section accepts a setting of restriction in cases where the first authentication information is not identical to the second authentication information.

16. The output control server of claim 11, wherein the output instruction comprises a save instruction for saving the job data by correlating with the output apparatus.

17. The output control server of claim 16, wherein the job data include data saved by the save instruction.

18. The output control server of claim 11, wherein the input control section displays apparatus icons, each of which corresponds to each of the plurality of output apparatuses, and a data icon corresponding to job data on an operation screen, wherein when receiving a drag and drop operation, where the data icon is dragged and dropped on the apparatus icon, generates the output instruction.

19. The output control server of claim 18, wherein the input control section controls to display a layout image on the operation screen, and to display an apparatus icon in the layout image.

20. The output control server of claim 11, wherein the authentication information is an IP address of the information processing terminal.

21. A data output system in which an information processing terminal, a plurality of output apparatuses, and an output control server are connected with via network, wherein the output control server comprising:
a communication section for receiving an output instruction to transmit job data for outputting to the output apparatus, and for receiving the job data pertaining to the output instruction from the information processing terminal;
a memory for storing the job data received by the communication section, and a first authentication information for specifying a user who has conducted a generating operation of the output instruction or for specifying an information processing terminal where the generating operation of the output instruction has been conducted, wherein the first authentication information is correlated with the job data; and
a control section including an input control section, a first acquisition control section, a transmission control section, a second acquisition control section and an authentication section,
wherein the input control section transmits display data to the information processing terminal to display an operation screen, and to generate an output instruction for outputting selected job data at an output apparatus selected by a first selection method, when receiving a decision operation for outputting data after receiving a job data selection operation and an output apparatus selection operation by the first selection method from a user,
the first acquisition control section controls to obtain the first authentication information,
the transmission control section controls to withhold transmission of the job data to the output apparatus until the output apparatus, which has been selected as the output destination becomes a state of being able to execute processing of the job data,
the second acquisition control section controls, when receiving a selection operation of an output apparatus by a second selection method via the operation screen, to obtain a second authentication information for specifying a user who has conducted the selection operation or for specifying an information processing terminal where the selection operation has been conducted,
the authentication section controls to compare the second authentication information and the first authentication information, which has been correlated with the job data, transmission of the job data to the output apparatus selected by the second selection method having been withheld, and to authenticate the job data when the first authentication information is identical to the second authentication information, and
the input control section controls to accept a change operation for changing setting information only pertaining to the job data, which have been authenticated by the authentication section, when receiving a selection operation of the output apparatus by the second selection method.
